(19) United States
(12) Patent Application Publication
(10) Pub. No.: US 2025/0370832 A1
(43) Pub. Date: Dec. 4, 2025

(54) MANAGEMENT COMPONENT TRANSPORT PROTOCOL

(71) Applicant: Axiado Corporation, San Jose, CA (US)

(72) Inventors: Alexander BACHMUTSKY, Sunnyvale, CA (US); Raghu KONDAPALLI, San Jose, CA (US); Siddhartha ADATRAO, San Jose, CA (US)

(21) Appl. No.: 19/220,586

(22) Filed: May 28, 2025

Related U.S. Application Data
(60) Provisional application No. 63/652,929, filed on May 29, 2024.

(51) Int. Cl. G06F 9/54; G06F 13/42

(52) U.S. Cl. CPC G06F 9/546; G06F 13/4234; G06F 2209/547; G06F 2213/0016; G06F 2213/0026

(57) ABSTRACT

Described herein are systems and methods for processing a message comprising a management component transport protocol (MCTP). In some instances, the message comprising the MCTP may be processed by a MCTP Offload Engine (MOE).

### CROSS-REFERENCE TO RELATED APPLICATIONS

This application claims the benefit of U.S. Provisional Application No. 63/652,929, filed May 29, 2024, which is incorporated by reference herein in its entirety.

### BACKGROUND

Management Component Transport Protocol (MCTP) generally refers to a protocol designed by the Distributed Management Task Force (DMTF) to support communications between different intelligent hardware components of a system. MCTP can be used for the purpose of monitoring and controlling functions of the components. This protocol can be independent of the underlying physical interfaces, as well as the data link layer messaging.

MCTP is, for instance, used to control Network Interface Cards (NICs) and other system components, or for the required functionality of a generic Board Management Controller (BMC).

### SUMMARY

Provided herein is a computer-implemented method of receiving a message by a system comprising: (a) receiving a message comprising a management component transport protocol (MCTP); and (b) processing the message by a MCTP offload engine (MOE), wherein processing comprises one or more operations comprising; (i) verifying the message in part by verifying that a destination endpoint comprises a component of the system; (ii) determining a length of the message; (iii) mapping one or more characteristics of the message as one or more of interactions between one or more components of the system; and (iv) reassembling the message in part based on the one or more interactions, thereby generating a reassembled message. In some embodiments, the system is a system-on-a-chip (SoC). In some embodiments, the message is received by a port of the SoC. In some embodiments, receiving the messages comprises processing the message by a peripheral component interconnect express (PCIe), I2C/SMB, I3C, or any combination thereof. In some embodiments, the PCIe handles instructions to transfer data in the message to a target memory or transfer the data from a Host memory. In some embodiments, the message comprises an indication of a memory address and length. In some embodiments, further comprising transferring the message by the MOE from a mailbox of the PCIe into a memory close to a central processing unit (CPU). In some embodiments, the memory close to the CPU comprises a cache, tightly coupled memory (TCM), or static random-access memory (SRAM). In some embodiments, the CPU processes the message, extracts the memory address and the length, and passes data back to the MOE. In some embodiments, the PCIe verifies validity of a header, extracts a message length, reads the message, or verifies a requester or target identifications. In some embodiments, the I2C/SMB verifies a source and destination identification, extracts a byte count, or reads the message. In some embodiments, the I3C verifies a destination address or receives bytes encoding the message. In some embodiments, reading the message comprises reading bytes encoding the message. In some embodiments, verifying the message further comprises verifying message by a PCIe or an I2C/SMB. In some embodiments, the PCIe verifies a vendor defined message (VDM) code, vendor identification (ID), or both. In some embodiments, the I2C/SMB verifies a command code. In some embodiments, one or more characteristics comprises the destination endpoint, a source endpoint, an owner tag, a message tag, or any combination thereof. In some embodiments, the one or more interactions comprises a communication interface, a data handling mechanism, or both. In some embodiments, the communication interface comprises a software (SW) interface or one or more ports, or both. In some embodiments, the data handling mechanism comprises first-in, first-out (FIFO), context, or both. In some embodiments, reassembling the message comprises one or more operations comprising: (A) generating a context comprising a user defined portion and at least one buffer, wherein the at least one buffer is sized to contain at least a portion of the message; (B) receiving a packet of the message comprising a payload; (C) calculating a payload length and a checksum value of the message; and (D) copying the payload into the at least one buffer. In some embodiments, the user defined portion comprises user defined data. In some embodiments, the user defined data comprises a socket identification. In some embodiments, the message comprises more than one packet. In some embodiments, (B)-(D) are repeated for the more than one packet, wherein a subsequent payload is copied into a subsequent buffer of the at least one buffer. In some embodiments, the message comprises more than one concurrent contexts based in part on the one or more characteristics of the message. In some embodiments, the message is reassembled for the more than one concurrent contexts. In some embodiments, further comprising delivering the reassembled message to an application of the system.

Also provided herein is a computer-implemented method of transmitting a message by a system comprising: (a) receiving a message from an application of the system, wherein the message comprises a management component transport protocol (MCTP); and (b) processing the message by a MCTP offload engine (MOE), wherein processing comprises one or more operations comprising: (i) mapping one or more characteristics of the message as one or more target interface types; and (ii) fragmenting the message to generate a plurality of fragmented messages. In some embodiments, the one or more target interface types comprises a peripheral component interconnect express (PCIe), I2C/SMB, I3C, or any combination thereof. In some embodiments, receiving the message comprises receiving a header and a payload length. In some embodiments, processing the message further comprises one or more operations comprising: extracting a header; and calculating a checksum and appending it to the end of the message or replacing an existing checksum in the message. In some embodiments, fragmenting comprises: (A) generating a header for a given payload; (B) appending the given payload to the header; and (C) prepending the target interface header. In some embodiments, the message comprises more than one payload. In some embodiments, (A)-(C) are repeated for the more than one payload. In some embodiments, further comprising transmitting at least a portion of the plurality of fragmented messages to a target interface. In some embodiments, the target interface comprises a peripheral component interconnect express (PCIe), I2C/SMB, or I3C. In some embodiments, transmitting the message to the PCIe comprises transferring data into a Host memory or from a target memory of the system. In some embodiments, the message comprises an indication of a memory address and length. In some embodiments, transmitting the message to the PCIe comprises transferring the message a memory close to a CPU. In some embodiments, the memory close to the CPU comprises a cache, tightly coupled memory (TCM), or static random-access memory (SRAM). In some embodiments, CPU generates a PCIe message and indicates to the MOE a readiness of the PCIe message. In some embodiments, the PCIe message is transmitted via a PCIe mailbox. In some embodiments, further comprising acknowledging a status to the application that the message is transmitted.

Further provided herein is a computer-implemented system comprising: at least one processor, a memory, and instructions executable by the at least one processor comprising: (a) one or more interface controllers; (b) one or more applications; and (c) an MCTP offload engine (MOE) for processing a message comprising a management component transport protocol (MCTP), wherein the MOE performs one or more operations comprising: (i) reassembling the message received through the one or more communication protocols, thereby generating a reassembled message that is delivered to the one or more applications; (ii) fragmenting the message transmitted from the one or more applications, thereby generating a plurality of fragmented messages that are processed through the one or more communication protocols; or (iii) both. In some embodiments, the one or more interface controllers comprise one or more communication protocols. In some embodiments, the one or more communication protocols comprise a peripheral component interconnect express (PCIe), I2C/SMB, I3C, or any combination thereof. In some embodiments, the MOE process the message inline between the one or more interface controllers and the one or more applications. In some embodiments, the MOE process the message lookaside, wherein the message is diverted from a data path between the one or more interface controllers and the one or more applications. In some embodiments, the MOE interacts directly with one or more physical interfaces. In some embodiments, the one or more physical interfaces comprise one or more ports. In some embodiments, reassembling the message comprises: (A) generating a context comprising a user defined portion and at least one buffer, wherein the at least one buffer is sized to contain at least a portion of the message; (B) receiving a packet of the message comprising a payload; (C) calculating a payload length and a checksum value of the message; and (D) copying the payload into the at least one buffer. In some embodiments, the user defined portion comprises user defined data. In some embodiments, the user defined data comprises a socket identification. In some embodiments, the message comprises more than one packet. In some embodiments, (B)-(D) are repeated for the more than one packet, wherein a subsequent payload is copied into a subsequent buffer of the at least one buffer. In some embodiments, the message comprises more than one concurrent contexts based in part on the one or more characteristics of the message. In some embodiments, the message is reassembled for the more than one concurrent contexts. In some embodiments, fragmenting the message comprises: (E) generating a header for a given payload; (F) appending the given payload to the header; and (G) prepending the target interface header. In some embodiments, the message comprises more than one payload. In some embodiments, (E)-(G) are repeated for the more than one payload.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIGS. 1A-1C shows a non-limiting example of management component transport protocol (MCTP) Offload Engine (MOE) implementation, according to some embodiments. FIG. 1A illustrates an embodiment of the MOE processing all data inline between applications and interface controllers. FIG. 1B illustrates an embodiment of the MOE interfacing physical interfaces directly. FIG. 1C illustrates an embodiment of the MOE used as inline or lookaside offload.

FIG. 2 shows a non-limiting example of a reassembly procedure on a MCTP message, according to some embodiments.

FIG. 3 shows a non-limiting example of a fragmentation procedure on a MCTP message, according to some embodiments.

FIG. 4 shows a non-limiting example of a computing device; in this case, a device with one or more processors, memory, storage, and a network interface.

FIG. 5 shows a non-limiting example of a web/mobile application provision system; in this case, a system providing browser-based and/or native mobile user interfaces.

FIG. 6 shows a non-limiting example of a cloud-based web/mobile application provision system.

### DETAILED DESCRIPTION

Many existing systems are very complex and large with hundreds and thousands of components and their various sub-components to monitor and control in real time. This can create millions or even tens of millions of control messages between a system controller entity and controlled components. Most messages can be relatively short (e.g., 64 to 512 bytes), but can require very fast, low latency and deterministic processing.

An MCTP protocol can be simple in its nature, but software processing can create real time challenges, such as header parsing and verification. Processing can also comprise message fragmentation and reassembly into packets supported by a particular underlying interface media for thousands of simultaneous contexts, calculation and verification of message integrity (checksum), delivering data to the correct application instance, routing packets to the desired interface, or aggregation of all data into offline system (can be connected over NC-SI).

Message formats over various interfaces may be specified in a corresponding binding specification document. Existing interface bindings include, by way of non-limiting example, PCI Express (PCIe), I2C, SMB, or I3C. This software complexity together with performance and latency requirements can call for a hardware offload engine. In some embodiments, an MCTP Offload Engine (MOE) can be implemented in various ways, as provided further herein.

Provided herein is a computer-implemented method of receiving a message by a system. In some instances, the method comprises one or more of: (a) receiving a message comprising a management component transport protocol (MCTP); and (b) processing the message by a MCTP offload engine (MOE). In some instances, processing comprises one or more operations comprises one or more of: (i) verifying the message in part by verifying that a destination endpoint comprises a component of the system; (ii) determining a length of the message; (iii) mapping one or more characteristics of the message as one or more of interactions between one or more components of the system; or (iv) reassembling the message in part based on the one or more interactions, thereby generating a reassembled message.

Provided herein is a computer-implemented method of transmitting a message by a system. In some instances, the method comprises one or more of: (a) receiving a message from an application of the system, wherein the message comprises a management component transport protocol (MCTP); and (b) processing the message by a MCTP offload engine (MOE). In some instances, processing comprises one or more operations comprises one or more of: (i) mapping one or more characteristics of the message as one or more target interface types; and (ii) fragmenting the message to generate a plurality of fragmented messages.

Provided herein is a computer-implemented system comprising: at least one processor, a memory, and instructions executable by the at least one processor. In some instances, the system comprises one or more interface controllers or one or more applications. In some instances, the system comprises a management component transport protocol (MCTP) offload engine (MOE). In some instances, the MOE processes a message comprising a MCTP. In some examples, the MOE performs one or more operations comprising: (i) reassembling the message received through the one or more communication protocols, thereby generating a reassembled message that is delivered to the one or more applications; (ii) fragmenting the message transmitted from the one or more applications, thereby generating a plurality of fragmented messages that are processed through the one or more communication protocols; or (iii) both.

### Overview

Provided herein are systems and methods comprising a MCTP Offload Engine (MOE) or the use thereof. In some instances, the system comprises a system-on-a-chip (SoC). In some examples, the SoC may be in communication with a network-on-a-chip (NIC). MCTP generally refers to a protocol for managing communication between components of a system. In some instances, the MCTP provides a communication framework across various interfaces. The interfaces (communication protocols) can comprise, in some examples, one or more of peripheral component interconnect express (PCIe), inter-integrated circuit (I2C)/system management bus (SMB), or improved inter-integrated circuit (I3C).

The message format for PCIe can generally comprise a PCIe header, PCIe data, PCIe transaction layer packet (TLP) digest, or any combination thereof. In some examples, the PCIe header comprises a PCIe vendor defined message (VDM) header. In some examples, the PCIe data comprises a PCIe VDM data. In some instances, the PCIe header can comprise a PCIe medium-specific header or a MCTP transport header. In some examples, the PCIe header comprises a requester identification (ID), a PCIe tag field, a message code that is vendor defined, a target ID, a vendor ID, a reserved field, a header version, a destination endpoint ID, source endpoint ID, start of message (SOM), end of message (EOM), packet sequence number, TO, or message tag. In some examples, the PCIe TAG field comprises a reserved field, padding, or a VDM code. In some instances, the PCI data can comprise a MCTP packet payload. In some examples, the packet payload comprises an indicator control (IC) field, message type, MCTP message header, MCTP message data, message integrity check, or a PCIe medium-specific trailer. In some examples, the MCTP message header varies based in part on the message type. In some examples, a message type byte is only present in a first packet header of the message. In some examples, the message data comprises more than one packet.

The message format for I2C/SMB can generally comprise one or more of a destination address command code, byte count, source address, reserved field, header version, destination endpoint identification, source endpoint identification, start of message (SOM), end of message (EOM), packet sequence number, TO, or message tag. In some instances, the message format for I2C/SMB can also comprise a message header and a message data. In some examples, the message header comprises an indicator control (IC) field and a message type. In some examples, the message data comprises a message integrity check. In some instances, the I2C/SMB message format further comprises a packet error code (PEC). The message format for I3C can similarly comprise one or more of a destination address, reserved field, header version, destination endpoint identification, source endpoint identification, start of message (SOM), end of message (EOM), packet sequence number, TO, or message tag. In some instances, the message format for I2C/SMB can also comprise a message header and a message data. In some examples, the message header comprises an IC field and a message type. In some examples, the message data comprises a message integrity check. In some instances, the I2C/SMB message format further comprises a PEC.

In some embodiments, the systems and methods provided herein comprise an offload engine. An offload engines may generally comprise a specialized hardware that can process or handle one or more specific tasks. In particular, the one or more specific tasks may comprise those that might be resource consuming tasks. By offloading the resource consuming tasks to a specialized hardware, the performance of the system may be improved. In some instances, the offload engine comprises an MCTP Offload Engine (MOE).

A system provided herein may generally comprise at least one processor, a memory, and instructions executable by the at least one processor. In some embodiments, the system comprises one or more applications. In some embodiments, the system comprises one or more interface controllers. The one or more interface controllers can comprise, in some cases, one or more communication protocols. The one or more communication protocols can comprise, by way of non-limiting example, PCIe, I2C/SMB, I3C, or any combination thereof. In some embodiments, the system comprises an offload engine. The offload engine can comprise, in some cases, an MCTP Offload Engine (MOE). The MOE may generally process a message comprising a MCTP. The MOE may perform one or more operations. In some instances, the MOE can process an incoming message to the system. When a system receives an message, the MOE may perform one or more operations comprising reassembling the message, as further described herein. In some examples, the message is received through one or more communication protocols. In some instances, the MOE can process an outgoing message from the system. When a system transmits a message, the MOE may perform one or more operations comprising fragmenting the message, as further described herein. In some examples, the message is transmitted from the one or more applications.

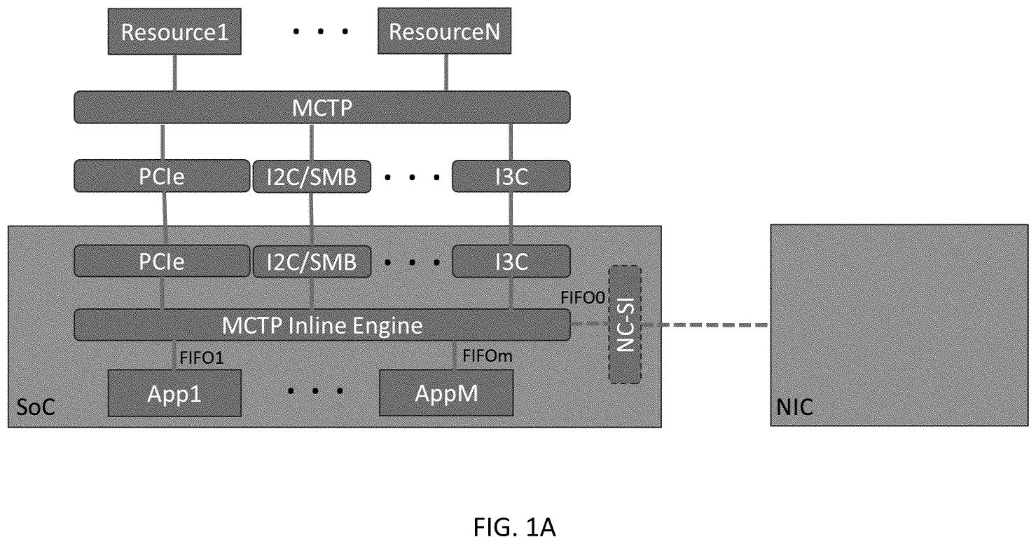

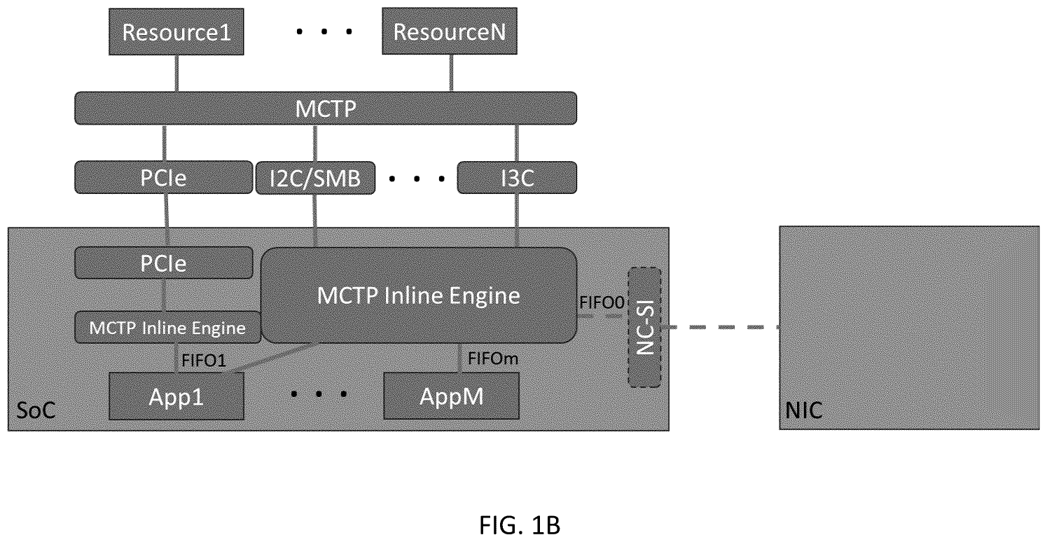

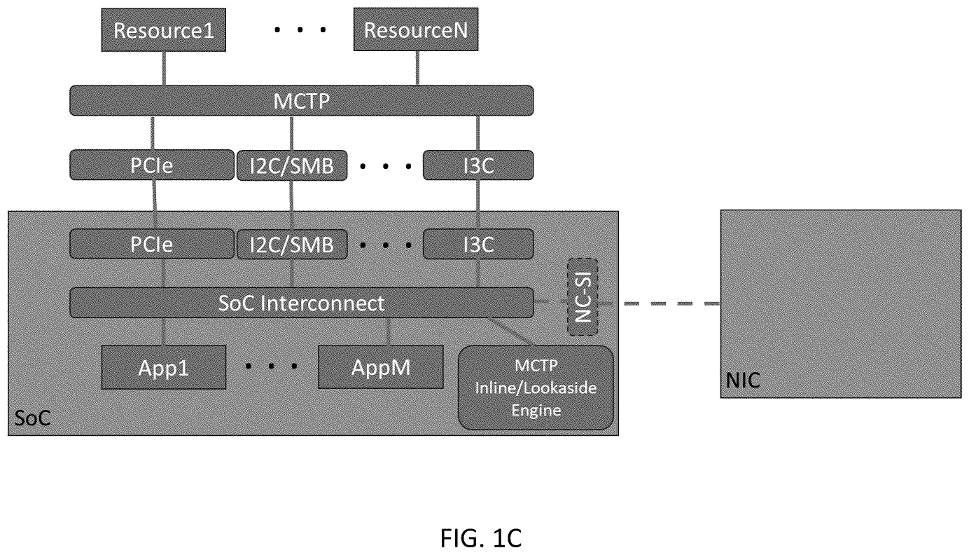

An offload engine may be implemented in more than one way. In one embodiment, the offload engine (e.g., MOE) processes data inline between one or more applications and one or more interface controllers. An exemplary schematic is provided in FIG. 1A. The system comprise an SoC, which may be in communication with NIC. In some instances, one or more resources transmits a message, which is received by the SoC through one or more communication protocols (e.g., PCIe, I2C/SMB, I3C) as shown, for example, in FIG. 1A. In some examples, the message comprises an management component transport protocol (MCTP). In some instances, the MOE processes data inline between one or more interface controllers and one or more applications. In such embodiments, the MOE processes data that flows from the one or more interface controllers to the one or more applications. Thus, the MOE may process data (e.g., MCTP message) directly within the path of the data transmission. In some examples, the MOE process some data (e.g., some MCTP messages) in line between one or more interface controllers and one or more applications. In some examples, the MOE process all data (e.g., all MCTP messages) in line between one or more interface controllers and one or more applications. Once the message is processed by the MOE, the message is transmitted to an application first in, first out (FIFO). In some examples, the message is transmitted through a network controlled sidebar interface (NC-SI) to NIC.

In another embodiment, an offload engine (e.g., MOE) interfaces with one or more physical interfaces directly. An exemplary schematic is provided in FIG. 1B. The system comprise an SoC, which may be in communication with NIC. In some instances, one or more resources transmits a message, which is received by the SoC through one or more communication protocols (e.g., PCIe, I2C/SMB, I3C) as shown, for example, in FIG. 1B. In some instances, the one or more physical interfaces can comprise one or more ports (e.g., ethernet port or USB port). In some instances, a physical interface comprises an PCIe slot. In some instances, a physical interface can comprise an I2C interface or an I3C interface. In some examples, a component of an I2C or an I3C interface can comprise a serial data line (SDA) or a serial clock line (SCL). Once the message is processed by the MOE, the message is transmitted to an application FIFO. In some examples, the message is transmitted through a network controlled sidebar interface (NC-SI) to NIC.

In another embodiment, the MOE is used inline or lookaside, as shown for example in FIG. 1C. The system comprise an SoC, which may be in communication with NIC. In some instances, one or more resources transmits a message, which is received by the SoC through one or more communication protocols (e.g., PCIe, I2C/SMB, I3C) as shown, for example, in FIG. 1C. In some instances, the MOE processes the message directly within the path as it flows from an interface controller and an application. In some instances, the MOE processes a message that is temporarily diverted from the data path between the one or more interface controllers and the one or more applications. In some examples, once the message is sent to an offload engine, it is processed and returned to the data path to be transmitted to the one or more applications. In some instances, the MOE can process the message inline and lookaside. Once the message is processed by the MOE, the message is transmitted to an application FIFO. In some examples, the message is transmitted through a network controlled sidebar interface (NC-SI) to NIC.

Provided herein are methods for receiving a message by a system comprising an offload engine. A system provided herein (e.g., FIGS. 1A-1C) may receive a message. The message may be received by one or more ports of the system (e.g., SoC). In some instances, the message is received through a interface controller, as described herein. In some instances, the message comprises an management component transport protocol (MCTP). In some instances, the process for receiving is optionally accelerated when it is received from PCIe. The PCIe may be involved in transferring data into a target memory of the system (e.g., push mode) or transferring data from the Host memory (e.g., pull mode). In some examples, a short PCIe message with indication for the transferred one or more memory addresses and lengths may be transferred into the target memory or from the host memory. In some instances, the MOE transfers received PCIe message from a PCIe mailbox into a memory close to the CPU. A memory close to a CPU may comprise, by way of non-limiting example, cache, Tightly Coupled Memory (TCM), or local SRAM. In such instances, the CPU may process the PCIe message, extract information related to the one or more memory addresses or lengths, and pass the information back to the MOE.

In some embodiments, when a message is received by the one or more interface controllers, it may process the message. In some instances, the PCIe verifies the header validity, extracts the length, reads the message, including for example, some or all bytes based on the length of the message, or verifies the requested or target identification. In some examples, the PCIe is dedicated to MCTP. In such examples, the PCIe processes only MCTP traffic. The PCIe Physical or Virtual Function may be for MCTP only. In some examples, some checks or header formats are optimized. In some instances, the I2C/SMB verifies a source or destination identification, extracts a byte count, reads the message, by for example, reading the bytes based on that length. In some instances, the I3C verifies a destination address, or receives all bytes until a Start or Stop.

In some embodiments, an offload engine, such as an MOE, performs one or more operations. The one or more operations can comprise (i) verifying the message; (ii) determining a length of the message; (iii) mapping one or more characteristics of the message as one or more of interactions between one or more components of the system; or (iv) reassembling the message in part based on the one or more interactions. The one or more operation can generate a reassembled message. In some cases, verifying the message comprises verifying that the message is for the system it is received by (e.g., verify that the message is for this SoC or MOE instance). In some instances, the message is verified by its destination endpoint (e.g., destination endpoint ID=this SoC/MOE instance). In some cases, if the message is not for the system (e.g., not for this SoC or MOE instance), then it is delivered to a special port or FIFO. In some cases, the message received through a PCIe is verified for its MCTP VDM code or vendor identification (e.g., Vendor ID=DMTF), or both. In some instances, the message received through a I2C/SMB is verified for its command code (e.g., command code=MCTP (0×F)). In some instances, the message received through a I3C is not verified.

In some instances, the message is processed by the offload engine (e.g., the MOE). In some cases, a message or packet length is determined. In some instances, the MCTP packet is processed by one or more operations. In some examples, the MOE maps one or more characteristics of a message as one or more interactions between one or more components of the system. The one or more characteristics can comprise, in some examples, a destination endpoint ID, source endpoint ID, tag owner, message tag, or any combination thereof. The one or more interactions between the one or more system components can comprise a communication interface or a data handling mechanism, or a combination thereof. In some examples, the one or more interactions can comprise a software (SW) interface, one or more ports, first-in first-out (FIFO), or context, or any combination thereof. The MOE may present itself as more than one destination endpoints and may maintain many simultaneous contexts depending on an implementation or configuration. The implementation or configuration may comprise, in some examples, any one of FIGS. 1A-1C.

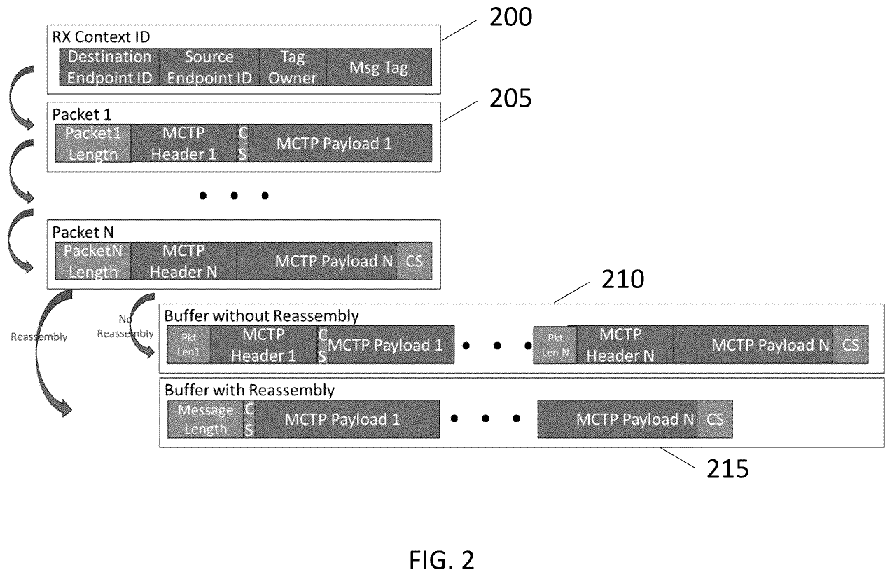

An offload engine may reassemble a message. In some embodiments, the MOE may reassemble the message by a reassembly procedure. An exemplary reassembly procedure is illustrated in FIG. 2. In some instances, the reassembly procedure comprises generating a context 200. In some instances, a message (e.g., MCTP message) comprises more than one concurrent contexts based in part on the one or more characteristics of a message. The one or more characteristics may be used to generate a receive (RX) context ID 200. If a message comprises more than one context, then the reassembly procedure described herein may be repeated for the more than one concurrent contexts.

The RX context ID 200 may comprise one or more of, for example, destination endpoint ID, source endpoint ID, tag owner, or message tag. The maximum number of concurrent reassembly contexts may be defined by combinations of the one or more characteristics (e.g., the destination endpoint ID, source endpoint ID, tag owner, or message tag). A context may comprise a user defined portion and at least one buffer. The user defined portion may comprise data transparent to the accelerator or may be passed to the software after the offload engine for reference. In some examples, the user defined data can comprise a socket ID, e.g., Linux OS socket ID. In some examples, the at least one buffer is sized to comprise at least a portion of the message. For example, a buffer may be sized for a largest possible MCTP message. The buffer may comprise, in some instances, one or more properties comprising the buffer address (e.g., address of memory for the socket ID if Linux socket) or an offset (e.g., offset=0 if current offset in the buffer).

In some embodiments, the one or more operations comprises receiving a packet of the message comprising a payload. In some instances, the one or more operations comprises calculating a payload length, a checksum value, or both. In some instances, the message comprises more than one packet. For example, each packet 205 may comprise a packet length, MCTP header, a checksum, and an MCTP payload. Assembly of the packets without reassembly procedure 210 may comprise appending each subsequent packet to a prior packet. Assembly of the packets with the reassembly procedure 215 may comprise copying the payload into the at least one buffer. If the message comprises more than one packet, the reassembly procedure is repeated such that a subsequent payload is copied into a subsequent buffer of the at least one buffer. Once a message is reassembled, as shown in FIG. 2, it may be delivered to one or more applications of the system.

In some examples, each context is configured initially to ExpectSOM=1 (where the next packet must be with SOM set to one indicating the first packet of the message) and ExpectSeq #=ANY (any sequence number is accepted), MessageCSEnable=0 (no checksum), and MessageCS=0 (current checksum value). If a received packet does not meet expectation (SOM or sequence number), then the packet may be sent to a slow path (without acceleration) or silently dropped as per a configuration. If PacketSOM=1 (e.g., SOM is set in the MCTP packet header), ExpectedSeq #may be set to a PacketSeq #, where a sequence number is renumbered based on the sequence number value in the MCTP header of the first packet in the message. If the PacketCSEnable=1 (checksum is enabled in the first packet of the MCTP message), then MessageCSEnable=1 (remember that this message has checksum enabled). An MCTP payload length may then be calculated (e.g., length of MCTP payload in the current MCTP packet). If PacketCSEnable=1, then a current MessageCS (current message checksum value) is calculated. The current message checksum value may be either a final checksum when there is only one packet in the message, or partial checksum for multi-packet message. The MCTP payload may then be copied into a BufferAddress+Offset. In this process if EOM (end of message)=0, meaning more packets are expected for this MCTP message, then ExpectSOM=0 (where following packets for this message must not have the first packet indication). The expected sequence number in the next packet is then set as ExpectSeq #=(PacketSeq #+1) modulo 4, since the MCTP sequence number may be 2-bit value, and hence mod4 calculation may be used. The buffer offset is then adjusted for the next packet: Offset+=PayloadLength. In some examples, the packet is the last packet of the MCTP message, e.g., EOM=1. In such examples, if the PacketCSEnable==0, or PacketCSEnable==1 and PacketCS==MessageCS (e.g., no or correct checksum), then the user defined data and optional buffer properties are pushed to, for example, DataReceivedFIFO (indication of message readiness for the application to process). The MOE may then prepare for the next message with ExpectSOM=1, ExpectSeq #=ANY and a new buffer if available. Otherwise, e.g., if there is a checksum error, the user defined data and optional buffer properties are sent on a slow path or silently drop as per configuration.

Further provided herein are methods for transmitting a message by a system comprising an offload engine. A system provided herein (e.g., FIGS. 1A-1C) may transmit a message. The message may be transmitted by one or more applications. In some instances, the message is processed by an offload engine prior to being transmitted to one or more interface controllers, such as those described herein. In some instances, the message comprises an management component transport protocol (MCTP). In some instances, the message is received from an application. The message can comprise a header, a message (or payload) length, or both. In some instances, the message is received from an application with payload data (or address to payload data), length with context ID, or both. In some examples, the message is received from an application with the context ID mapped into a preconfigured MCTP header.

In some embodiments, an offload engine, such as an MOE, performs one or more operations. The one or more operations may be performed on a message prior to transmitting the message. For example, the MOE may process an MCTP packet from an application prior to its transmission. Processing may comprise one or more of: (i) mapping one or more characteristics of the message as one or more target interface types; or (ii) fragmenting the message to generate a plurality of fragmented messages. The one or more characteristics can, in some examples, destination endpoint ID, source ID, tag owner, or message tag. The one or more target interface types or ID may comprise, in some examples, PCIe, I2C/SMB, or I3C. In some instances, the one or more operations comprises extracting a header from the message transmitted from an application. In some instances, the one or more operations comprises calculating a checksum and appending it to the end of the message or replacing an existing checksum in the message transmitted from an application.

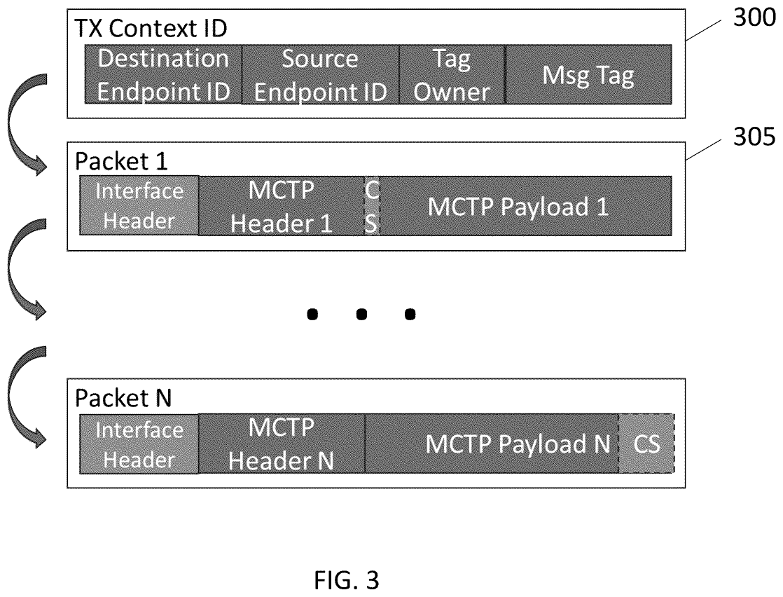

In some instances, the MOE may fragment the message by a fragmentation procedure. An exemplary fragmentation procedure is illustrated in FIG. 3. The fragmentation procedure may generally comprise using a transmit (TX) context ID 300 to generate one or more packets 305. In some instances, fragmentating comprises one or more of: (a) generating a header for a given payload; (b) appending the given payload to the header; and/or (c) prepending the target interface header. In some examples, one or more headers for a given target interface (e.g., PCIe, I2C, I3C) are preconfigured. In some instances, the message comprises more than one payload. In some instances, the fragmentation is repeated for some or all of the more than one payload. This process can generate a plurality of fragmented messages. In some instances, at least a portion of or all of the plurality of fragmented messages are transmitted to a target interface.

In some examples, one or more headers (e.g., for PCIe, I2C, or I3C) are pre-configured by software during an initialization stage of the offload engine (e.g., the MOE). The one or more headers may be preconfigured prior to receiving a message from an application. The message received from an application generally comprises a header and a payload length. The header may be an MCTP header and the payload length may be the MCTP payload length, in accordance with some embodiments. In some examples, the MOE extracts the MCTP header. In some instances, if an integrity (checksum) bit is set, then a checksum can be calculated, if preconfigured. In some examples, the calculated checksum is updated or added at the end of the message. In some examples, a preconfigured source endpoint ID is updated if needed.

In some embodiments, the offline engine (e.g., MOE) maps one or more characteristics, such as the destination endpoint ID, source endpoint ID, tag owner, or message tag, as one or more target interfaces. In some instances, the MOE generates a random sequence number for the first packet. In some examples, a sequence number is configured to be a specific value for a given context. In some examples, the MCTP header is updated and SOM is set to 1. If a message is larger than a maximum packet size, then EOM can be set to zero. Otherwise, the EOM can be set to 1. The current sequence number Seq # is then copied and the first data chunk of MCTP payload is appended to the MCTP header up to the max packet size. A target interface header (e.g., PCIe, I2C, or I3C header) is then prepended, as shown for example in FIG. 3. In some examples, a length in a PCIe or I2C header is be updated.

In some instances, the packet is sent to a target interface, such as PCIe, I2C, or I3C. In some examples, the packet comprises one or more headers, a payload, a checksum, or a combination thereof (e.g., 305). In some examples, the packet comprises a PCIe, I2C, or I3C header, a MCTP header, a MCTP payload data, or any combination thereof. In some instances, the packet is additionally accelerated for PCIe. The message may be transmitted to the PCIe by transferring data into the Host memory (e.g., push mode) or transferring data by the Host from the SoC memory (e.g., pull mode). In some examples, the message transmission to the PCIe involves short PCIe messages sent by the SoC with an indication of transferred or to be transferred one or more memory addresses or lengths. In some examples, the MOE transfers information about data to be transmitted over PCIe (e.g., one or more memory addresses and lengths) into the memory close to the CPU (e.g., cache, TCM, local SRAM). The CPU may generate one or more PCIe messages in the required format and indicate message readiness to MOE. The MOE may then transmit message(s) via PCIe mailbox.

The MOE may perform one or more operations on the remaining packets. In some examples, for each remaining data chunk up to a maximum packet size, a sequence number Seq # (mod 4) is incremented and SOM (first packet of the message indication) set to zero. If a remaining or unsent message is larger than a maximum packet size, then EOM (last packet of MCTP message indication) may be set to zero; otherwise, it may be set to 1. The current sequence number Seq # may then be copied and appended to the next data chunk up to the max packet size of MCTP payload to MCTP header. The interface (e.g., PCIe, I2C, I3C) header is then prepended. The packet may then be sent to a target interface. For example, the packet can comprise a PCIe header, MCTP header, and MCTP payload data, which may be sent to PCIe. In another example, the packet can comprise a I2C header, MCTP header, and MCTP payload data, which may be sent to I2C. In another example, the packet can comprise a I3C header, MCTP header, and MCTP payload data, which may be sent to I3C. In some examples, an acknowledge, such as a “sent” status, is delivered to the application using, for example, DataTransmittedFIFO. Otherwise if a message size is larger than max packet size, then a NACK (negative acknowledgement) is delivered to the application (not supported feature) using, for example, Data TransmittedFIFO.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing System

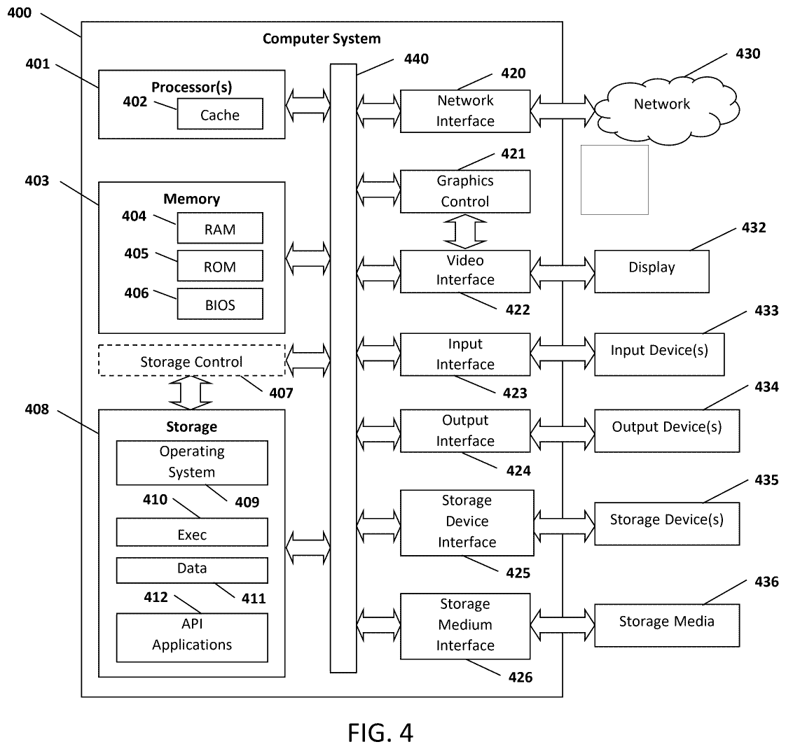

Referring to FIG. 4, a block diagram is shown depicting an exemplary machine that includes a computer system 400 (e.g., a processing or computing system) within which a set of instructions can execute for causing a device to perform or execute any one or more of the aspects and/or methodologies of the present disclosure. In some embodiments, the system comprises an MCTP Offload Engine (MOE) that processes a message comprising a MCTP, as described herein. In some embodiments, the MOE of the system performs one or more operations, including reassembling the message (e.g., FIG. 2) or fragmenting the message (e.g., FIG. 3), as described herein. The components in FIG. 4 are examples only and do not limit the scope of use or functionality of any hardware, software, embedded logic component, or a combination of two or more such components implementing particular embodiments.

Computer system 400 may include one or more processors 401, a memory 403, and a storage 408 that communicate with each other, and with other components, via a bus 440. The bus 440 may also link a display 432, one or more input devices 433 (which may, for example, include a keypad, a keyboard, a mouse, a stylus, etc.), one or more output devices 434, one or more storage devices 435, and various tangible storage media 436. All of these elements may interface directly or via one or more interfaces or adaptors to the bus 440. For instance, the various tangible storage media 436 can interface with the bus 440 via storage medium interface 426. Computer system 400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers. In some embodiments, the computer system 400 may comprise one or more interface controllers, such as a communication protocol (e.g., PCIe, I2C/SMB, I3C) as described herein.

Computer system 400 includes one or more processor(s) 401 (e.g., central processing units (CPUs), general purpose graphics processing units (GPGPUs), or quantum processing units (QPUs)) that carry out functions. Processor(s) 401 optionally contains a cache memory unit 402 for temporary local storage of instructions, data, or computer addresses. Processor(s) 401 are configured to assist in execution of computer readable instructions. Computer system 400 may provide functionality for the components depicted in FIG. 4 as a result of the processor(s) 401 executing non-transitory, processor-executable instructions embodied in one or more tangible computer-readable storage media, such as memory 403, storage 408, storage devices 435, and/or storage medium 436. The computer-readable media may store software that implements particular embodiments, and processor(s) 401 may execute the software. Memory 403 may read the software from one or more other computer-readable media (such as mass storage device(s) 435, 436) or from one or more other sources through a suitable interface, such as network interface 420 or an interface controller. The software may cause processor(s) 401 to carry out one or more processes or one or more steps of one or more processes described or illustrated herein. The one or more processes can comprise reassembling the message or fragmenting the message as described herein. Carrying out such processes or steps may include defining data structures stored in memory 403 and modifying the data structures as directed by the software.

In some embodiments, the system may comprise a specialized engine for offloading specific tasks from a CPU. In some instances, the specific tasks is resource intensive. By having a specialized engine to handle the task, the system may run more efficiently. In some examples, the task comprises processing a management component transport protocol (MCPT), as described herein. Thus, having a MCTP Offload Engine (MOE) that can handle, for example, thousands of simultaneous contexts, calculation and verification of message integrity (checksum), data delivery to the correct application instance, packet routings to the desired interface, or aggregation of all data into offline system (e.g., connected over NC-SI), can allow the system to run more efficiently. A specialized engine can comprise one or more dedicated processors, one or more hardware modules, or both. The specialized engine can comprise, in some instances, a network interface card (NIC), one or more GPUs, or one or more RAID controllers. In some cases, the specialized engine handles data across a network, such as one or more of TCP/IP processing, encryption or decryption, packet filtering, or any combination thereof. In some cases, the specialized engine handles one or more of RAID calculations, data compression/decompression, or data duplication, or any combination thereof. In some cases, the specialized engine handles image processing or 3D rendering. In some embodiments, a specialized engine is integrated into the system by one or more integration points. The one or more integration points comprise, by way of non-limiting example, a peripheral component interconnect express (PCIe), a direct memory access (DMA), or bus interface (e.g., I2C/SMB, I3C), such as those described herein. In some instances, the specialize engine (e.g., MOE) process messaged in line between one or more integration points or interface controllers and one or more applications, as described herein (e.g., FIG. 1A). In some instances, the specialize engine (e.g., MOE) process messaged lookaside between one or more integration points or interface controllers and one or more applications, as described herein (e.g., FIG. 1B). In some instances, the specialize engine (e.g., MOE) interfaces directly with one or more physical interfaces (e.g., FIG. 1C), such as those provided herein.

The memory 403 may include various components (e.g., machine readable media) including, but not limited to, a random access memory component (e.g., RAM 404) (e.g., static RAM (SRAM), dynamic RAM (DRAM), ferroelectric random access memory (FRAM), phase-change random access memory (PRAM), etc.), a read-only memory component (e.g., ROM 405), and any combinations thereof. ROM 405 may act to communicate data and instructions unidirectionally to processor(s) 401, and RAM 404 may act to communicate data and instructions bidirectionally with processor(s) 401. ROM 405 and RAM 404 may include any suitable tangible computer-readable media described below. In one example, a basic input/output system 406 (BIOS), including basic routines that help to transfer information between elements within computer system 400, such as during start-up, may be stored in the memory 403. In some embodiments, a message received by the system is transferred by an offload engine (e.g., MOE) of the present disclosure from a PCIe mailbox to a memory close to a CPU, such as, by way of non-limiting example, a cache, TCM, or SRAM. In some embodiments, a message transmitted by the system to a PCIe mailbox is transferred to a memory close to a CPU, such as, by way of non-limiting example, a cache, TCM, or SRAM.

Fixed storage 408 is connected bidirectionally to processor(s) 401, optionally through storage control unit 407. Fixed storage 408 provides additional data storage capacity and may also include any suitable tangible computer-readable media described herein. Storage 408 may be used to store operating system 409, executable(s) 410, data 411, applications 412 (application programs), and the like. Storage 408 can also include an optical disk drive, a solid-state memory device (e.g., flash-based systems), or a combination of any of the above. Information in storage 408 may, in appropriate cases, be incorporated as virtual memory in memory 403.

In one example, storage device(s) 435 may be removably interfaced with computer system 400 (e.g., via an external port connector (not shown)) via a storage device interface 325. Particularly, storage device(s) 435 and an associated machine-readable medium may provide non-volatile and/or volatile storage of machine-readable instructions, data structures, program modules, and/or other data for the computer system 400. In one example, software may reside, completely or partially, within a machine-readable medium on storage device(s) 435. In another example, software may reside, completely or partially, within processor(s) 401.

Bus 440 connects a wide variety of subsystems. Herein, reference to a bus may encompass one or more digital signal lines serving a common function, where appropriate. Bus 440 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X or PCIe) bus, an Accelerated Graphics Port (AGP) bus, HyperTransport (HTX) bus, serial advanced technology attachment (SATA) bus, and any combinations thereof.

Computer system 400 may also include an input device 433. In one example, a user of computer system 400 may enter commands and/or other information into computer system 400 via input device(s) 433. Examples of an input device(s) 433 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 433 may be interfaced to bus 440 via any of a variety of input interfaces 423 (e.g., input interface 423) including, but not limited to, serial, parallel, game port, USB, FIREWIRE, THUNDERBOLT, or any combination of the above.

In particular embodiments, when computer system 400 is connected to network 430, computer system 400 may communicate with other devices, specifically mobile devices and enterprise systems, distributed computing systems, cloud storage systems, cloud computing systems, and the like, connected to network 430. Communications to and from computer system 400 may be sent through network interface 420. For example, network interface 420 may receive incoming communications (such as requests or responses from other devices) in the form of one or more packets (such as Internet Protocol (IP) packets) from network 430, and computer system 400 may store the incoming communications in memory 403 for processing. Computer system 400 may similarly store outgoing communications (such as requests or responses to other devices) in the form of one or more packets in memory 403 and communicated to network 430 from network interface 420. Processor(s) 401 may access these communication packets stored in memory 403 for processing.

Examples of the network interface 420 include, but are not limited to, a network interface card, a modem, and any combination thereof. Examples of a network 430 or network segment 430 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 430, may employ a wired and/or a wireless mode of communication. In general, any network topology may be used.

Information and data can be displayed through a display. Examples of a display 432 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 432 can interface to the processor(s) 401, memory 403, and fixed storage 408, as well as other devices, such as input device(s) 433, via the bus 440. The display 432 is linked to the bus 440 via a video interface 422, and transport of data between the display 432 and the bus 440 can be controlled via the graphics control 421.

In addition to a display 432, computer system 400 may include one or more other peripheral output devices 434 including, but not limited to, an audio speaker, a printer, a storage device, and any combinations thereof. Such peripheral output devices may be connected to the bus 440 via an output interface 424. Examples of an output interface 424 include, but are not limited to, a serial port, a parallel connection, a USB port, a FIREWIRE port, a THUNDERBOLT port, and any combinations thereof.

In addition or as an alternative, computer system 400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, netbook computers, netpad computers, handheld computers, Internet appliances, mobile smartphones, and tablet computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD, Linux, Apple Mac OS X Server, Oracle Solaris, Windows Server, and Novell NetWare. Those of skill in the art will recognize that suitable personal computer operating systems include, by way of non-limiting examples, Microsoft Windows, Apple Mac OS X, UNIX, and UNIX-like operating systems such as GNU/Linux. In some embodiments, the operating system is provided by cloud computing.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more applications. The one or more applications can comprise, in some instances, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft SQL Server, mySQL, and Oracle. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash ActionScript, JavaScript, or Silverlight. In some embodiments, a web application is written to some extent in a server-side coding language such as Active Server Pages (ASP), ColdFusion, Perl, Java, JavaServer Pages (JSP), Hypertext Preprocessor (PHP), Python, Ruby, Tcl, Smalltalk, WebDNA, or Groovy. In some embodiments, a web application is written to some extent in a database query language such as Structured Query Language (SQL). In some embodiments, a web application integrates enterprise server products such as IBM Lotus Domino. In some embodiments, a web application includes a media player element. In various further embodiments, a media player element utilizes one or more of many suitable multimedia technologies including, by way of non-limiting examples, Adobe Flash, HTML 5, Apple QuickTime, Microsoft Silverlight, Java, and Unity.

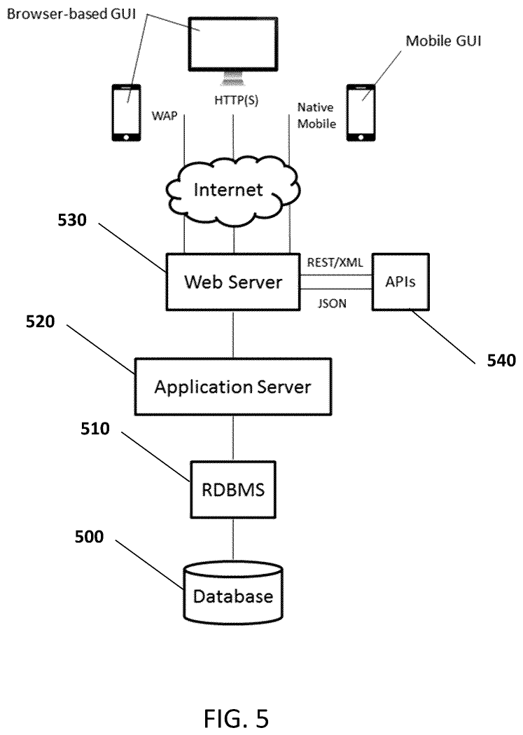

Referring to FIG. 5, in a particular embodiment, an application provision system comprises one or more databases 500 accessed by a relational database management system (RDBMS) 510. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 520 (such as Java servers, .NET servers, PHP servers, and the like) and one or more web servers 530 (such as Apache, IIS, GWS and the like). The web server(s) optionally expose one or more web services via app application programming interfaces (APIs) 540. Via a network, such as the Internet, the system provides browser-based and/or mobile native user interfaces.

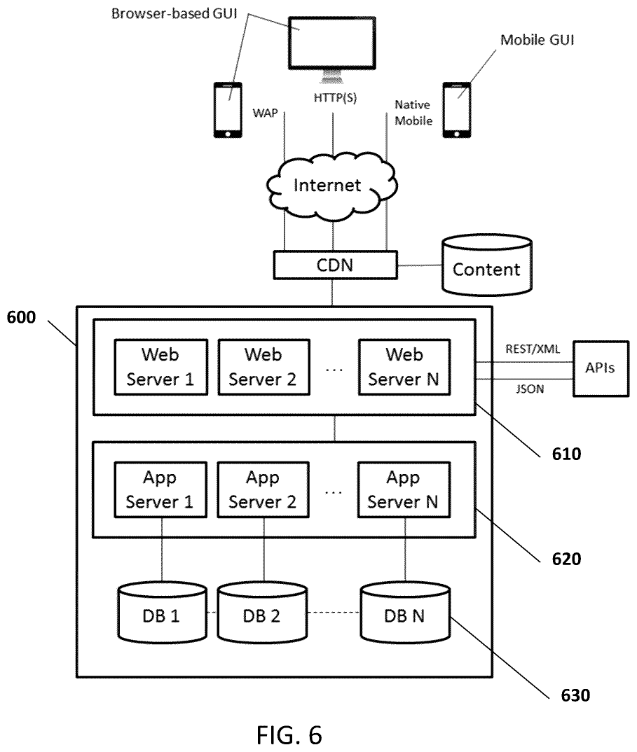

Referring to FIG. 6, in a particular embodiment, an application provision system alternatively has a distributed, cloud-based architecture 600 and comprises elastically load balanced, auto-scaling web server resources 610 and application server resources 620 as well synchronously replicated databases 630.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java, JavaScript, Pascal, Object Pascal, Python, Ruby, VB .NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java, Lisp, Python, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, by way of examples, assets and information of owners. In various embodiments, suitable databases include, by way of non-limiting examples, relational databases, non-relational databases, object-oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### EXAMPLES

The following illustrative examples are representative of embodiments of the software applications, systems, and methods described herein and are not meant to be limiting in any way.

### Example 1—Receiving a Message by an Management Component Transport Protocol (MCTP) Offload Engine (MOE)

A message is received by a system-on-a-chip (SoC). The message is received by any one of PCIe, I2C/SMB, or I3C. The SoC has an offload engine for processing the incoming messages, including those with a management component transport protocol (MCTP). The SoC has an MCTP offload engine (MOE) inline for processing the message in the data path between one or more interface controllers and one or more applications, as shown in FIG. 1A. In some embodiments, the MOE is configured as shown in FIG. 1B (interfacing with a physical interface) or FIG. 1C (inline or lookaside).

The MOE processed the message by mapping one or more characteristics of the message into one or more of a software interface, port, FIFO, or context. The MOE maintains simultaneous contexts depending on the MOE implementation or configuration. For a given receive (RX) context ID, a plurality of packets are reassembled as shown in FIG. 2. For a given packet, a payload length and a checksum value of the message is calculated and the payload is copied into at least one buffer. Once the one or more payloads are reassembled, it can be delivered to an application of the system.

### Example 2—Transmitting a Message by an MCTP Offload Engine (MOE)

A message is transmitted by a SoC. The message is transmitted by an application of the system. The SoC has an MCTP offload engine (MOE) inline for processing the message in the data path between one or more interface controllers and one or more applications, as shown in FIG. 1A. In some embodiments, the MOE is configured as shown in FIG. 1B (interfacing with a physical interface) or FIG. 1C (inline or lookaside).

The MOE processed the message by mapping one or more characteristics of the message into one or more target interfaces, such as PCIe, I2C/SMB, or I3C. The MOE maintains simultaneous contexts depending on the MOE implementation or configuration. For a given transmit (TX) context ID, a message may be fragmented a plurality of packets, as shown in FIG. 3. The fragmenting can comprise generating a header for a given payload, appending the payload to the header, and prepending the target interface header to the fragmented message.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented method of receiving a message by a system comprising:
(a) receiving a message comprising a management component transport protocol (MCTP); and
(b) processing the message, by a MCTP offload engine (MOE), wherein the processing comprises:
(i) verifying the message in part by verifying that a destination endpoint comprises a component of the system;
(ii) determining a length of the message;
(iii) mapping one or more characteristics of the message as one or more of interactions between one or more components of the system; and
(iv) reassembling the message in part based on the one or more interactions, thereby generating a reassembled message.

2. The method of claim 1, wherein the system is a system-on-a-chip (SoC).

3. The method of claim 2, wherein the message is received by a port of the SoC.

4. The method of claim 1, wherein receiving the messages comprises processing the message by a peripheral component interconnect express (PCIe), I2C/SMB, I3C, or any combination thereof.

5. The method of claim 4, wherein the PCIe handles instructions to transfer data in the message to a target memory or transfer the data from a Host memory.

6. The method of claim 5, wherein the message comprises an indication of a memory address and length.

7. The method of claim 5, further comprising transferring the message by the MOE from a mailbox of the PCIe into a memory close to a central processing unit (CPU).

8. The method of claim 7, wherein the memory close to the CPU comprises a cache, tightly coupled memory (TCM), or static random-access memory (SRAM).

9. The method of claim 8, wherein the CPU processes the message, extracts the memory address and the length, and passes data back to the MOE.

10. The method of claim 4, wherein the PCIe verifies validity of a header, extracts a message length, reads the message, or verifies a requester or target identifications.

11. The method of claim 10, wherein reading the message comprises reading bytes encoding the message.

12. The method of claim 4, wherein the I2C/SMB verifies a source and destination identification, extracts a byte count, or reads the message.

13. The method of claim 4, wherein the I3C verifies a destination address or receives bytes encoding the message.

14. The method of claim 1, wherein verifying the message further comprises verifying message by a PCIe or an I2C/SMB.

15. The method of claim 14, wherein the PCIe verifies a vendor defined message (VDM) code, vendor identification (ID), or both.

16. The method of claim 14, wherein the I2C/SMB verifies a command code.

17. The method of claim 1, wherein one or more characteristics comprises the destination endpoint, a source endpoint, an owner tag, a message tag, or any combination thereof.

18. The method of claim 1, wherein the one or more interactions comprises a communication interface, a data handling mechanism, or both.

19. The method of claim 18, wherein the communication interface comprises a software (SW) interface or one or more ports, or both.

20. The method of claim 18, wherein the data handling mechanism comprises first-in, first-out (FIFO), context, or both.

21. The method of claim 1, wherein the reassembling the message comprises:
(A) generating a context comprising a user defined portion and at least one buffer, wherein the at least one buffer is sized to contain at least a portion of the message;
(B) receiving a packet of the message comprising a payload;
(C) calculating a payload length and a checksum value of the message; and
(D) copying the payload into the at least one buffer.

22. The method of claim 21, wherein the user defined portion comprises user defined data.

23. The method of claim 22, wherein the user defined data comprises a socket identification.

24. The method of claim 21, wherein the message comprises more than one packet.

25. The method of claim 24, wherein (B)-(D) are repeated for the more than one packet, wherein a subsequent payload is copied into a subsequent buffer of the at least one buffer.

26. The method of claim 21, wherein the message comprises more than one concurrent contexts based in part on the one or more characteristics of the message.

27. The method of claim 26, wherein the message is reassembled for the more than one concurrent contexts.

28. The method of claim 1, further comprising delivering the reassembled message to an application of the system.

29. A computer-implemented method of transmitting a message by a system comprising:
(a) receiving a message from an application of the system, wherein the message comprises a management component transport protocol (MCTP); and
(b) processing the message, by a MCTP offload engine (MOE), wherein the processing comprises:
(i) mapping one or more characteristics of the message as one or more target interface types; and
(ii) fragmenting the message to generate a plurality of fragmented messages.

30. The method of claim 29, wherein the one or more target interface types comprises a peripheral component interconnect express (PCIe), I2C/SMB, I3C, or any combination thereof.

31. The method of claim 29, wherein receiving the message comprises receiving a header and a payload length.

32. The method of claim 29, wherein processing the message further comprises one or more operations comprising: extracting a header; and calculating a checksum and appending it to the end of the message or replacing an existing checksum in the message.

33. The method of claim 29, wherein the fragmenting the message comprises:
(A) generating a header for a given payload;
(B) appending the given payload to the header; and
(C) prepending the target interface header.

34. The method of claim 33, wherein the message comprises more than one payload.

35. The method of claim 34, wherein (A)-(C) are repeated for the more than one payload.

36. The method of claim 29, further comprising transmitting at least a portion of the plurality of fragmented messages to a target interface.

37. The method of claim 36, wherein the target interface comprises a peripheral component interconnect express (PCIe), I2C/SMB, or I3C.

38. The method of claim 36, wherein transmitting the message to the PCIe comprises transferring data into a Host memory or from a target memory of the system.

39. The method of claim 38, wherein the message comprises an indication of a memory address and length.

40. The method of claim 36, wherein transmitting the message to the PCIe comprises transferring the message a memory close to a CPU.

41. The method of claim 40, wherein the memory close to the CPU comprises a cache, tightly coupled memory (TCM), or static random-access memory (SRAM).

42. The method of claim 40, wherein CPU generates a PCIe message and indicates to the MOE a readiness of the PCIe message.

43. The method of claim 42, wherein the PCIe message is transmitted via a PCIe mailbox.

44. The method of claim 29, further comprising acknowledging a status to the application that the message is transmitted.

45. A computer-implemented system comprising: at least one processor, a memory, and instructions executable by the at least one processor comprising:
(a) one or more interface controllers;
(b) one or more applications; and
(c) an MCTP offload engine (MOE) for processing a message comprising a management component transport protocol (MCTP), wherein the MOE performs operations comprising one or more of:
(i) reassembling the message received through the one or more communication protocols, thereby generating a reassembled message that is delivered to the one or more applications; and
(ii) fragmenting the message transmitted from the one or more applications, thereby generating a plurality of fragmented messages that are processed through the one or more communication protocols.
